(19) United States
(12) Patent Application Publication
(10) Pub. No.: US 2007/0063105 A1
(43) Pub. Date: Mar. 22, 2007

(54) Apparatus for controlling temperature in satellites

(76) Inventor: Alfred E. Mann, Beverly Hills, CA (US)

Correspondence Address: MARY ELIZABETH BUSH;QUALLION LLC, P.O. BOX 923127, SYLMAR, CA, 91392-3127, US

(21) Appl. No.: 11/055,287

(22) Filed: Feb. 9, 2005

Related U.S. Application Data
(60) Provisional application No. 60/543,211, filed on Feb. 10, 2004.

(51) Int. Cl. B64G 1/52

(52) U.S. Cl. 244/171.8

(57) ABSTRACT

Disclosed is a method and apparatus for maintaining the temperature of thermally sensitive components in a satellite within a preferred operating range. The apparatus employs a heat absorber disposed between the outer hull of the satellite and the components. The heat absorber includes heat-absorbing material preferably exhibiting a phase change at a temperature within a preferred operating range of the components.

### REFERENCE TO RELATED APPLICATIONS

This application claims the benefit of U.S. Provisional Patent Application Ser. No. 60/543,211, filed on Feb. 10, 2004, entitled “Apparatus for Controlling Temperature in Satellites;” and is a Continuation in Part of U.S. patent application Ser. No. 10/500,907, filed Jul. 2, 2004, entitled “Method and Apparatus for Amplitude Limiting Battery Temperature Spikes;” which is the National Stage of International Application No. PCT/US03/00565, filed on Jan. 8, 2003, and published in English under PCT Article 21(2) on Jul. 24, 2003, entitled “Method and Apparatus for Amplitude Limiting Battery Temperature Spikes;” which claims the benefit of U.S. patent application Ser. No. 10/042,898, filed on Jan. 9, 2002, now U.S. Pat. No. 6,586,912, issued on Jul. 1, 2003, entitled “Method and Apparatus for Amplitude Limiting Battery Temperature Spikes;” each of which is incorporated herein in its entirety.

### TECHNICAL FIELD

This invention relates generally to satellites, e.g., manned and unmanned spacecraft in near earth orbit or in stationary orbit. More particularly, this invention relates to a method and apparatus for controlling the temperature within such satellites to keep batteries and other components within the satellites at or near their optimal operating temperature.

### BACKGROUND

Satellites orbiting the earth undergo extreme temperature conditions. During the portion of the orbit in which the satellite is exposed to the sun, heat is radiated from the sun to the satellite. During the portion of the orbit in which the satellite is shielded from the sun by the earth, heat is radiated from the satellite to the sky. Depending on the velocity and orbit of the satellite, the cycle of heat and cold can vary. As an example of a near earth orbiting satellite, the Hubble Space Telescope takes 90 minutes to orbit the earth once, at a speed of 17,000 m.p.h., spending approximately 45 minutes in sun and about 45 minutes in shade. Stationary satellites complete their orbit in 24 hours, with about 12 hours in sun and 12 hours in shade.

In addition to the heat impinging from the sun and being lost to the night sky, cyclic heat may be generated by devices on board the satellite that operate in a cyclical fashion.

Batteries and electronic components can be adversely affected or badly damaged from temperature extremes, having upper and lower limits on their operating temperatures, as well as a range in which they operate with maximum efficiency. For batteries, these limits depend partly on the battery chemistry. Although various battery chemistries have been used, nickel cadmium (NiCd), nickel hydrogen, and lithium rechargeable chemistries have evolved to generally be the battery of choice for satellites. All of these chemistries operate optimally in a range of about 15° C.±10° C.

Unfortunately, controlling the temperature within orbiting spacecraft is difficult. Reflective shielding and insulation are used extensively in satellites to minimize temperature excursions with the cycling from sun to shade and back but are not adequate to maintain a satisfactory temperature range. Complex heating and cooling systems are typically used to control temperature in critical portions of the spacecraft, such as manned portions or those having temperature-sensitive components, such as aerospace batteries. These complicated systems require substantial energy to run.

### SUMMARY

The present invention is directed to a method and apparatus for maintaining batteries and electronic components on board a satellite within an optimal temperature range. This method and apparatus can manage heat radiated to and from the satellite as a result of cycles of sun and shade. Furthermore, this method and apparatus can also manage heat generated from within the satellite itself, such as by cyclic battery heating. As used herein, energy storage devices will be generically referred to as “batteries”, and both batteries and electronic components will be collectively referred to as “components”. Furthermore, although this invention will be described with respect to maintaining “components” at a critical operating temperature, it should be understood that this invention may also be used for keeping any manned portion of a satellite within a specific temperature range, such as 13° C. to 30° C. Therefore, throughout this discussion, where it makes sense, the term “components” can also refer to a manned portion of the satellite.

In accordance with the invention, a heat absorber is positioned within the satellite to absorb heat from the sun and to release it to the sky when the satellite is shaded. The heat absorber comprises high heat capacity heat absorbing material that allows storage and release of considerable heat energy, thereby reducing the heat transferred from the sun to the components, and from the components to the night sky. This, in turn, maintains the temperature of the components within an optimal operating range.

Furthermore, in accordance with a preferred embodiment, the heat absorbing material is selected to exhibit a phase change at a temperature within an optimum operating temperature range of temperature-sensitive components within the satellite.

In accordance with an exemplary embodiment, the components are positioned such that they are spaced from the hull to minimize heat transference therebetween. In one aspect of the invention, the satellite hull is lined with insulation, and a heat absorber is mounted between the satellite hull insulation and the temperature-sensitive components to absorb heat energy and reduce the heat transference from the satellite hull. The hull may be hollow, forming a container that is filled with melted heat absorbing material to form the heat absorber. In another aspect of the invention, heat absorbing material may surround only a portion of the satellite containing temperature-sensitive components, or a portion that is manned, as part of the air conditioning system. In another aspect of the invention, the heat absorbing material may be contained within a battery housing, either surrounding cells or within the cells of the battery.

### BRIEF DESCRIPTION OF THE DRAWINGS

FIG. 1 is a schematic view of an exemplary satellite having an insulated hull, heat absorbing material, and components;

FIG. 2 is a schematic view of an exemplary satellite having an insulated hull, two separate portions of heat absorbing material, and components in thermal contact with a first portion of heat absorbing material and isolated from a second portion of heat absorbing material;

FIG. 3 is a hypothetical chart of temperatures experienced by portions of the satellite throughout two full orbits;

FIG. 4 is a hypothetical chart of temperatures experienced by portions of the satellite throughout two full orbits wherein two different heat absorbing materials having different melting points are used; and

FIG. 5 is a hypothetical chart of temperatures experienced by portions of the satellite throughout two full orbits wherein advantage is taken of two different phase changes within the same heat absorbing material.

### DETAILED DESCRIPTION

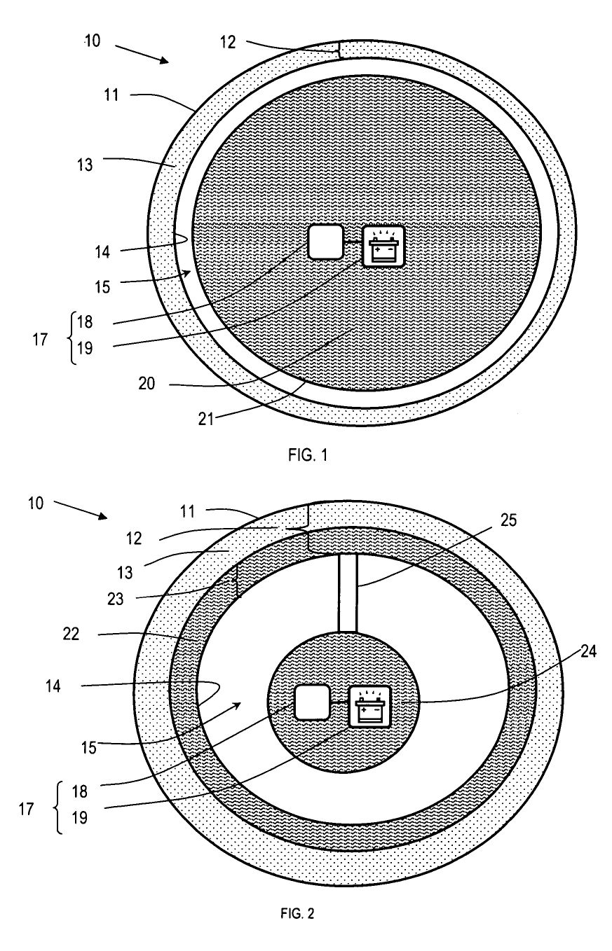

FIG. 1 illustrates an exemplary satellite 10 comprising a hull 12 having an outermost skin 11 and an inward-facing surface 14 defining a satellite interior volume 15 in which are positioned temperature-sensitive components 17, including electronic circuitry 18 and a battery 19 such as a rechargeable lithium ion battery for driving the electronic circuitry 18. The present invention is primarily directed to providing a method and apparatus for maintaining the temperature of the components 17 within acceptable operating limits.

The outermost skin 11 of hull 12 preferably comprises a reflective material to reflect radiation. The hull 12 preferably includes insulation 13, which may be positioned within hull 12 as shown. Alternatively or additionally, insulation (not shown) may be provided on the surface 14 of hull 12 that faces toward the center of satellite 10, i.e., between hull 12 and components 17. Temperature-sensitive components 17 are preferentially placed away from hull 12, while less temperature-sensitive components (not shown) may be placed closer to the hull.

Because the reflective skin and insulation are not enough to maintain temperature of the components 17 within acceptable operating limits, temperature excursions are further limited by using a heat absorber 20 positioned at a location between the outermost skin 11 of the hull 12 and temperature-sensitive components 17. In FIG. 1, the heat absorber 20 occupies its own container 21 within the satellite interior volume 15. This container 21 is shown spaced from the inward-facing surface 14 of the hull 12. Alternatively, the container 21 may be in direct thermal contact with surface 14. As another alternative, surface 14 of the hull 12 may form the container for holding the heat absorber 20. Although the heat absorber 20 is shown completely surrounding components 17, the heat absorber 20 may, as an alternative, only partially surround components 17. Furthermore, components 17 may directly contact the heat absorber 20 or may be housed in a separate housing in direct thermal contact with the heat absorber 20.

The heat absorber 20 preferably comprises a high heat capacity heat absorbing material that absorbs heat from the sun and releases heat back to the sky through hull 12, and absorbs and releases cyclic heat generated by components 17. In accordance with a preferred embodiment, the heat absorbing material is selected to exhibit a phase change, melting at a temperature within the preferred operating conditions of the components. The quantity of heat absorbing material is preferably chosen to be sufficient to keep the components within their preferred operating range. As an example, lithium ion and NiCd batteries operate best in a range of 15° C.±10° C., and the heat absorbing material is preferably selected to exhibit a phase change at a temperature within a range of about 5° C. to 25° C. and provided in a quantity the maintains the batteries within this range. Although the optimum operating range may be 15° C.±10° C., the batteries will tolerate a larger operating range of about −15° C. to 60° C.; therefore, an alternative design tradeoff is to reduce the mass of heat absorber 20 and allow the temperature to fluctuate between these wider limits.

FIG. 2 shows another embodiment of satellite 10 having two separate portions of heat absorbing material, global heat absorber 22 and local heat absorber 24. Components 17 are thermally isolated from global heat absorber 22 by spacer 19 and are in thermal contact with local heat absorber 24.

As above, the outermost skin 11 of hull 12 preferably comprises a reflective material to reflect radiation. The hull 12 preferably includes insulation 13, which may be positioned within hull 12 as shown. Hull 12 forms a hollow space, creating a container 23 for containing global heat absorber 22, which is used primarily to absorb heat from the sun and release heat to the night sky to minimized temperature fluctuations of components 17. A preferred heat absorber is formed by depositing melted heat absorbing material into the hollow space within hull 12 so that the material surrounds components 17 while remaining thermally separated from them by a spacer 19 to prevent heat conduction from the hull 12 to the components 17. Heat absorber 22 is shown lining essentially all of hull 12, either filling a hollow space within the hull (as shown) or within a separate compartment (not shown) on its inward-facing surface 14. Alternatively, the heat absorber 22 may line only a portion of hull 12. Additional insulation (not shown) may be provided between hull 12 and components 17.

Local heat absorber 24 is used primarily to even out heat fluctuations due to cyclic heat generated by components 17. Local heat absorber 24 is in thermal contact with components 17 and located apart from hull 12, and may be used with global heat absorber 22, as shown in FIG. 2, or without it. Components 17 may directly contact heat absorber 24 or may be housed in a separate housing in direct thermal contact with heat absorber 24. Components 17 may comprise a battery of cells having heat absorbing material contained within a battery housing, either surrounding or within the cells of the battery. The structures and locations of the heat absorber can be any disclosed with respect to the system for eliminating temperature spikes of U.S. Pat. No. 6,586,912, which is assigned to the assignee of the present invention and incorporated herein by reference. These include locations within a cell, outside a cell but within a battery case, or outside a battery case but within a device powered by the battery.

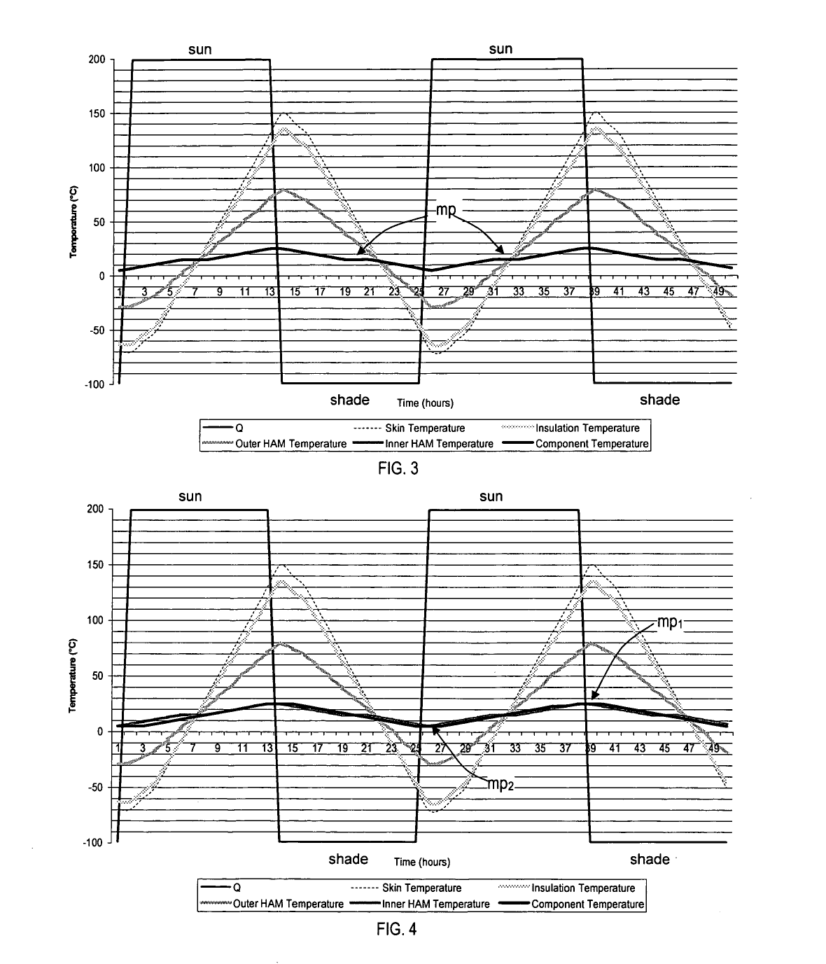

FIG. 3 is a hypothetical chart of temperatures experienced by portions of the satellite shown in FIG. 1 throughout two full orbits. The heat Q into the satellite is shown as occurring essentially as a step function, with heat going into the satellite when in the sun, and heat leaving the satellite when in shade. For this example, only the effects of external heating and cooling are considered, with heat generation by components 17 being ignored. Hypothetical typical temperature excursions of the skin 11, insulation 13, inner and outer regions of the heat absorber 20, and components 17 are shown. The plots depict hypothetical reduced temperature excursions attributable to the use of heat absorbing material in accordance with the invention. As can be seen in the component temperature plot, the temperature plateaus at the melting point (mp) of the heat absorbing material, both during melting and freezing.

The amount of heat energy Q that can be absorbed by the heat absorber is dependent on the quantity and characteristics of the heat absorbing material used. This relationship can be expressed as:

$$Q = {\int }_{{T}_{L}}^{{T}_{H}} {C}_{p} \cdot ⅆ T + {H}_{f} ( if mp is between {T}_{L } and {T}_{H} ) + {H}_{v} ( if bp is between {T}_{L } and {T}_{H} )$$

where
Q represents heat energy absorbed
T_{L} represents low temperature
T_{H} represents high temperature
Cₚ represents the heat capacity of the heat absorbing material
H_{f} represents the heat of fusion
Hᵥ represents the heat of vaporization
mp represents the melting point
bp represents the boiling point

The following table depicts properties of examples of heat absorbing materials for different applications. The actual heat absorbed by the heat absorber will depend on the high and low temperatures reached by the heat absorber. In this table, for each material, Q is calculated based on temperature excursions given as T_{L} and T_{H}.

| | Cp | H_{f} | Hᵥ | mp | bp | Q | T_{L} | T_{H} |
|---|---|---|---|---|---|---|---|---|
| Material | (J/g° C.) | (J/g) | (J/g) | (° C.) | (° C.) | (J/g) | (° C.) | (° C.) |
| Water | 2.1 | 333 | 2260 | 0 | 100 | 2800 | 0 | 100 |
| Benzene | 1.738 | 126 | 33.87 | 5.53 | 80.09 | 340 | 0 | 100 |
| Formic acid | 2.16 | 245 | 20.11 | 8.27 | 100.56 | 480 | 0 | 101 |
| 1,4-Dioxane | 1.71 | 142 | 35.62 | 11.8 | 101.32 | 350 | 0 | 102 |
| Glycerol | 1.63 (s) | 197 | 977 | 23 | 290 | 420 | 0 | 100 |
| | 2.39 (l) | | | | | | | |
| Paraffin | 3.26 (s) | 147 | 163 | 58 | 300 | 460 | 0 | 100 |
| | 2.89 (l) | | | | | | | |
| Beeswax | | 175.8 | | 62.2-64 | >316 | | 0 | 100 |

Water is often referred to as the “gold standard” of phase change materials because of its high heat capacity and heats of fusion and vaporization. However, its low melting point limits its applicability. Also, although water may be used for components that operate close to 0° C., for embodiments in which the components are partly or completely immersed in the heat absorbing medium, it is preferred that the heat absorbing medium is nonconductive to prevent short circuits and noncorrosive to the contacted materials. In such applications, water would need to be deionized and free of any electrolytes that could cause a short circuit or corrosion.

Examples of materials having a melting point within the optimal operating temperature range of NiCd, nickel hydrogen, and lithium rechargeable batteries, about 15° C.±10° C., include benzene, formic acid, 1,4-dioxane, and glycerol.

Specialty phase change materials are formulated in a broad range of melting points. Examples of these materials include mixtures of waxes of different melting points, with different portions within a given formulation melting over a range of several degrees corresponding to the melting points of the various waxes in the mixture. Although paraffin is listed in the table as having a melting point of 58° C. to provide a specific example, a wide range of melting points is available depending on the formulation of the paraffin, with typical melting temperatures in the 40 to 68° C. range. Beeswax has a typical melting point range of about 62.2 to 64° C.

In addition to solid-to-liquid phase transition materials that make use of the latent heat of fusion, there are “dry” phase change materials that may provide advantages in some applications in which liquid containment or volume expansion is an issue. These include micro-encapsulated solid-liquid phase change composites and solid-solid organic phase change compounds that provide a latent heat of transition from one phase to another. See, for example, Wirtz et al., Thermal Management Using “Dry” Phase Change Materials, Proc. Fifteenth IEEE Semiconductor Thermal Measurement and Management Symposium, Mar. 9-11, 1999, San Diego Calif., IEEE #99CH36306.

FIG. 4 is a hypothetical chart of temperatures experienced by portions of the satellite shown in FIG. 1 throughout two full orbits. However, in this case, two different heat absorbing materials are used, having two different melting points, both within the preferred operating range of components 17. As in FIG. 3, the heat Q into the satellite is shown as occurring essentially as a step function, with heat going into the satellite when in the sun, and heat leaving the satellite when in shade. Again, only the effects of external heating and cooling are considered, with heat generation by components 17 being ignored. Hypothetical typical temperature excursions of the skin 11, insulation 13, inner and outer regions of the heat absorber 20, and components 17 are shown. The plots depict hypothetical reduced temperature excursions attributable to the use of two different heat absorbing materials having melting points at the high and low end of the preferred operating range of the components. As can be seen in the component temperature plot, the temperature plateaus at the melting points (mp₁ and mp₂) of the two heat absorbing materials. It should be understood that more materials may be used, each having its own melting point, and each slowing the temperature rise and fall at its melting point. Note that mp₁ and mp₂ are not limited to the extremes of the component operating range, and may fall anywhere within it, as long as sufficient additional energy can be absorbed above mp₁ and sufficient additional energy can be released below mp₂ to ensure that the components 17 remain within their preferred operating limits.

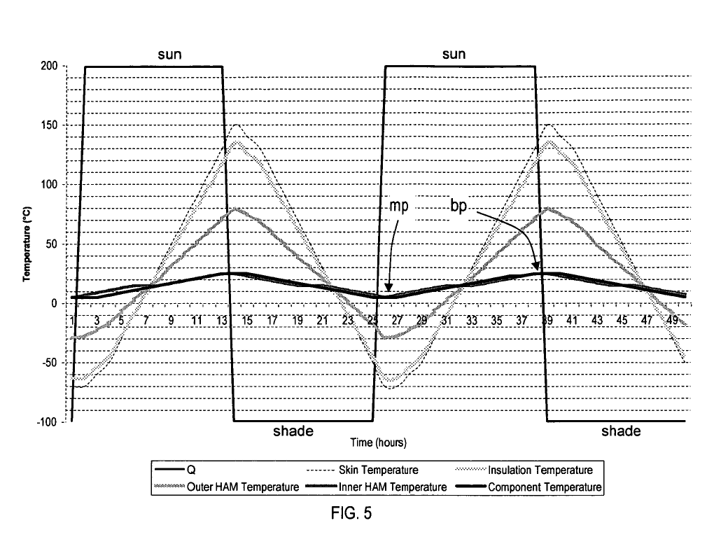

FIG. 5 is a hypothetical chart of temperatures experienced by portions of the satellite shown in FIG. 1 throughout two full orbits. However, in this case, a heat absorbing material is used that has both its melting point, mp, and its boiling point, bp, within the preferred operating range of components 17. As in FIGS. 3 and 4, the heat Q into the satellite is shown as occurring essentially as a step function, with heat going into the satellite when in the sun, and heat leaving the satellite when in shade. Again, only the effects of external heating and cooling are considered, with heat generation by components 17 being ignored. Hypothetical typical temperature excursions of the skin 11, insulation 13, inner and outer regions of the heat absorber 20, and components 17 are shown. The plots depict hypothetical reduced temperature excursions attributable to the use of a heat absorbing material having its boiling point at the high end and melting point at the low end of the preferred operating range of the components. As can be seen in the component temperature plot, the temperature plateaus at the boiling point and at the melting point of the heat absorbing material. Note that boiling point and melting point are not limited to the extremes of the operating range, and may fall anywhere within it; however, sufficient additional energy needs to be absorbed above its boiling point and sufficient additional energy needs to be released below its freezing point to ensure that the components 17 remain within their preferred operating limits. Furthermore, the pressure generated by the heat absorber at high temperatures must be considered, with adequate container strength and head space to allow for expansion. Closed bellows may be used to allow for expanding gas, as is known in the art.

As seen above, the heat absorbing materials may be used singly or in combination, and may be materials that undergo one or more phase changes during the complete thermal cycle. The choice of heat absorbing material depends in part on the preferred temperature range of temperature-sensitive components. Preferred materials have a high heat capacity and large latent heat of fusion and/or vaporization, depending on which phase changes will occur within the temperature range. Quantity of heat absorbing material required depends on the amount of energy that must be absorbed to keep from overheating or overcooling the temperature-sensitive components.

The above system has been described for maintaining temperature within a specified range for systems undergoing cyclic heat fluctuations. It may be used in conjunction with another system designed for eliminating temperature spikes as taught in U.S. Pat. No. 6,586,912, which is assigned to the assignee of the present invention and incorporated herein by reference. To use the system for eliminating temperature spikes of '912 with the system described herein for maintaining temperature undergoing cyclic heating and cooling, an additional quantity of heat absorbing material may be chosen to have a melting temperature higher than the normal operating range, but below the temperature at which components are damaged. The heat absorbing material for either or both purposes may be located in any of the locations taught in '912, or may be incorporated into a heat absorber in other locations as taught herein, for example, local heat absorber 24 surrounding temperature-sensitive components 17. These two different melting point materials may be in the same or different locations within the satellite. For example, components 17 having an optimal operating range of 5° C. to 25° C., maximum operating range of −15° C. to 60° C., and a maximum allowable temperature of 120° C. may have their temperature controlled by using benzene, formic acid, 1,4-dioxane, or glycerol having a melting point within the optimal operating range, combined with beeswax or high-melting point paraffin having a melting point above both the optimal and maximum operating ranges but below the maximum allowable temperature, thereby providing temperature control for both normal thermal cycling and temperature spikes. These materials may both be located in the same region, such as in local heat absorber 24 surrounding components 17; alternatively, they may be in separate regions, such as the beeswax within a battery casing, and glycerol outside the battery casing.

From the foregoing it should be appreciated that various configurations have been described for utilizing heat absorber material to control temperature in satellite components. Although multiple geometries have been depicted, it is recognized that various alternative and substantially equivalent arrangements will occur to those skilled in the art which fall within the spirit of the invention and the intended scope of the appended claims. Furthermore, although the examples of heat absorbers focused on physical phase transitions to make use of heats of fusion and/or vaporization, heat absorbers may alternatively or additionally comprise heat absorbing materials that undergo reversible chemical reactions to absorb and release heat as needed. Furthermore, the system of the present invention may be used with or without an active heating and cooling system.

1. A satellite, comprising:
a satellite hull defining an outermost skin and defining a satellite interior volume;
at least one component within the satellite interior volume, the component including a battery in a battery housing; and
a heat absorber positioned in the battery housing, the heat absorber having a phase transition that occurs in a range of −15° C. to 60° C.

2. The satellite of claim 1, wherein the heat absorber includes water.

3. The satellite of claim 1, wherein the heat absorber includes paraffin.

4. The satellite of claim 1, wherein the heat absorber includes beeswax.

5. The satellite of claim 1, wherein the range is 5° C. to 25° C.

6. The satellite of claim 5, wherein the phase transition is melting.

7. (canceled)

8. The satellite of claim 1, further comprising: a second material outside of the battery housing, the second material having a second phase transition that occurs at a temperature higher than 60° C., but lower than a maximum temperature at which the component can be operated.

9. The satellite of claim 8, wherein the second phase transition is melting.

10. The satellite of claim 9, wherein the second material includes paraffin.

11. The satellite of claim 9, wherein the second material includes beeswax.

12. The satellite of claim 1, wherein the heat absorber completely surrounds the component.

13-14. (canceled)

15. The satellite of claim 1, further comprising:
insulation between the hull outermost skin and the heat absorber.

16. (canceled)

17. The satellite of claim 1, wherein the satellite is in near-earth orbit.

18. The satellite of claim 1, wherein the satellite is in stationary orbit.

19. (canceled)

20. The satellite of claim 1, wherein the component includes a manned compartment.

21. A method for controlling temperature of a satellite component comprising:
providing a satellite hull defining an outermost skin and defining a satellite interior volume;
positioning at least one component within the interior volume,
the component including a battery in a battery housing, and
a heat absorber in the battery housing, the heat absorber having a phase transition that occurs in a range of −15° C. to 60° C.

22. The method of claim 21, wherein the range is 5° C. to 25° C.

23. The method of claim 22 wherein the phase transition is melting.

24. The method of claim 22 wherein, the heat absorber includes a second material having second phase transition that occurs at a temperature higher than 60° C., but lower than a maximum temperature at which the component can be operated.

25. The method of claim 24 wherein the second phase transition is melting.

26. (canceled)

27. The satellite of claim 1, wherein the heat absorber surrounds the battery.

28. The method of claim 21, wherein the heat absorber surrounds the battery.
